(19) United States
(12) Patent Application Publication
(10) Pub. No.: US 2024/0411998 A1
(43) Pub. Date: Dec. 12, 2024

(54) AUTOMATIC DIALOGUE METHOD AND SYSTEM BASED ON DEEP BI-DIRECTIONAL ATTENTION

(71) Applicant: Qilu University of Technology, Jinan City (CN)

(72) Inventors: Dongfeng Li, Jinan City (CN); Wanlong Dong, Jinan City (CN)

(21) Appl. No.: 18/207,236

(22) Filed: Jun. 8, 2023

(30) Foreign Application Priority Data
Sep. 28, 2022 (CN) 202211187080.7

(51) Int. Cl. G06F 40/35; G06F 40/284

(52) U.S. Cl. CPC G06F 40/35; G06F 40/284

(57) ABSTRACT

An automatic dialogue method and system based on deep bi-directional attention is provided, which belongs to the technical field of natural language processing and artificial intelligence. The technical problems to be solved by the present disclosure are how to alleviate a problem of information loss in the semantic encoding process and how to enhance semantic interaction between a historical dialogue and a candidate response, so as to improve prediction accuracy of an automatic dialogue. The adopted technical solution is as follows: the method includes acquiring an automatic dialogue data set, including downloading a published automatic dialogue data set from a network or building the automatic dialogue data set by itself, building an automatic dialogue model, including building an automatic dialogue model based on deep bi-directional attention; and training an automatic dialogue model, including training an automatic dialogue model on the automatic dialogue data set.

### CROSS-REFERENCE TO RELATED APPLICATIONS

This application claims priority to Chinese Patent Application No. 202211187080.7, filed on Sep. 28, 2022, which is hereby incorporated by reference in its entirety.

### TECHNICAL FIELD

The present disclosure relates to the technical field of natural language processing and artificial intelligence, in particular to an automatic dialogue method and system based on deep bi-directional attention.

### BACKGROUND

An automatic dialogue technology is an important way of human-computer interaction, which has been widely used in all aspects of society, such as intelligent customer services, intelligent assistants and search engines. As an important research direction in the whole computer field, the automatic dialogue technology has great research significance and application value. Due to different rounds of a dialogue, an automatic dialogue method can be divided into a single-round dialogue and a multi-round dialogue. The single-round dialogue only needs to judge a relationship between a question and a candidate response. The multi-round dialogue needs to judge a relationship between a plurality of historical dialogues and candidate responses, which is closer to an actual application scenario and is more challenging. In short, difficulties of the multi-round dialogue mainly include two points.

First, the historical dialogue sequence is too long, so that encoding process will inevitably lead to loss of a large amount of semantic information.

Second, due to the loss of semantic information caused by the encoding process, the interaction between the historical dialogue sequence and the candidate response is insufficient, which leads to inaccurate response prediction.

However, the existing multi-round dialogue method has not substantially solved the above technical problems. Therefore, the technical problem that needs to be solved urgently at present is how to alleviate the problem of information loss in the semantic encoding process and how to enhance the semantic interaction between the historical dialogue and the candidate response, so as to improve the prediction accuracy of an automatic dialogue.

### SUMMARY

The technical task of the present disclosure is to provide an automatic dialogue method and system based on deep bi-directional attention, so as to alleviate a problem of information loss in a semantic encoding process and enhance semantic interaction between a historical dialogue and a candidate response, so as to improve prediction accuracy of an automatic dialogue.

The technical task of the present disclosure is implemented in the following way. An automatic dialogue method based on deep bi-directional attention is provided, the method includes:
acquiring an automatic dialogue data set, including downloading a published automatic dialogue data set from a network or building an automatic dialogue data set by itself,
building an automatic dialogue model, including building the automatic dialogue model based on deep bi-directional attention; and
training the automatic dialogue model, including training the automatic dialogue model by using the automatic dialogue data set.

Preferably, building an automatic dialogue model includes:
building input data, including: for each piece of data in the automatic dialogue data set, concatenating all historical dialogue sentences, which are separated from each other by a space character “[SEP]” which is denoted as h (history); selecting a response from a plurality of responses as a current response which is formalized as r (response); determining a label of the piece of data according to whether the response is correct, wherein if the response is correct, the label is denoted as 1; otherwise, the label is denoted as 0; in which h, r and the label form an input data together;
embedding processing: performing embedding processing on the input data through a Token layer, a Segment layer and a Position layer, and adding embedded representations of the three layers to obtain a historical-dialogue embedded representation and a candidate-response embedded representation;
deep bi-directional attention encoding: performing longitudinal self-screening feature encoding operation and transverse interactive feature encoding operation on the historical-dialogue embedded representation and the candidate-response embedded representation by using a multi-layer encoder, so as to obtain a n-th historical-dialogue longitudinal self-screening feature representation, a n-th candidate-response longitudinal self-screening feature representation and a deep transverse interactive feature representation, which are denoted as \vec{Zₙ^{h}}, \vec{Zₙ^{r}} and \vec{I_{depth}};
feature compressing: using a layer of fully connected network Dense to perform mapping processing on the deep transverse interactive feature representation to obtain a mapped deep transverse interactive feature representation; and mapping a mapped deep transverse interactive feature representation by using a ReLU activation function, so as to obtain a transverse interactive feature representation \vec{I}, which is expressed as follows:

\vec{I}=ReLU(Dense(I_{depth}));

performing concatenating operation Concat on the n-th historical-dialogue longitudinal self-screening feature representation, the n-th candidate-response longitudinal self-screening feature representation, and the transverse interactive feature representation, so as to obtain a bi-directional feature representation \vec{B}, which is expressed as follows:

\vec{B}=Concat(\vec{Zₙ^{h}},\vec{Zₙ^{r}},\vec{I});

label predicting: subjecting the bi-directional feature representation as input to a layer of fully connected network with dimension 1 and an activation function Sigmod, so as to obtain a probability that the current response is a correct response.

More preferably, the embedding processing includes:
converting each word in the input data into a vector with a fixed dimension through the Token layer, so as to obtain an embedded representation of the Token layer;
differentiating different sentences in a historical dialogue sequence through the Segment layer, so as to obtain an embedded representation of the Segment layer;
identifying a position where each word in the input data is located through the Position layer, so as to obtain an embedded representation of the position layer;
adding the embedded representation of the Token layer, the embedded representation of the Segment layer and the embedded representation of the Position layer, so as to obtain a historical-dialogue embedded representation \vec{E^{h}} and a candidate-response embedded representation \vec{E^{r}}, which are expressed as follows:

$$\vec{{E}^{h}} = Token\_Emb ( h ) + Segment\_Emb ( h ) + Position\_Emb ( h ) ; \\ \vec{{E}^{r}} = Token\_Emb ( r ) + Segment\_Emb ( r ) + Position\_Emb ( r ) ;$$

where h represents a historical dialogue sequence; r represents a candidate-response sequence; Token_Emb( ) represents a Token layer embedding operation; Segment_Emb ( ) represents a Segment layer embedding operation; Position_Emb ( ) represents a Position layer embedding operation.

More preferably, deep bi-directional attention encoding includes:
performing encoding operation on the historical-dialogue embedded representation and the candidate-response embedded representation by a first-layer encoder Encoder₁, respectively, so as to obtain a first historical-dialogue encoded representation and a first candidate-response encoded representation, which are denoted as \vec{F₁^{h}} and \vec{F₁^{r}}, which are expressed as follows:

\vec{F₁^{h}}=Encoder₁(\vec{E^{h}});

\vec{F₁^{r}}=Encoder₁(\vec{E^{r}});

where \vec{E^{h}} represents the historical-dialogue embedded representation, \vec{E^{r}} represents the candidate-response embedded representation, and Encoder₁ represents a first-layer encoder;
performing cross-attention calculation on the first historical-dialogue encoded representation and the historical-dialogue embedded representation, so as to obtain a first historical-dialogue longitudinal self-screening feature representation, which is denoted as \vec{Z₁^{h}}; performing cross-attention calculation on the first candidate-response encoded representation and the candidate-response embedded representation, so as to obtain a first candidate-response longitudinal self-screening feature representation, which is denoted as \vec{Z₁^{r}}; performing concatenating operation on the first historical-dialogue encoded representation and the first candidate-response encoded representation, and using a self-attention mechanism to implement interactive processing there between, so as to obtain a first transverse interactive feature representation, which is denoted as \vec{I₁}, wherein the expressions are as follows:

$$\vec{{Z}_{1}^{h}} = Cross - Attention ( \vec{{F}_{1}^{h}} ; \vec{{E}^{h}} ) ; \\ \vec{{Z}_{1}^{r}} = Cross - Attention ( \vec{{F}_{1}^{r}} ; \vec{{E}^{r}} ) ; \\ \vec{{I}_{1}} = Self - Attention ( Concat ( \vec{{F}_{1}^{h}} ; \vec{{F}_{1}^{r}} ) ) ;$$

where \vec{F₁^{h}} represents the first historical-dialogue encoded representation; \vec{E^{h}} represents the historical-dialogue embedded representation; \vec{F₁^{r}} represents the first candidate-response encoded representation; \vec{E^{r}} represents the candidate-response embedded representation;
performing encoding operation on the first historical-dialogue longitudinal self-screening feature representation and the first candidate-response longitudinal self-screening feature representation by a second-layer encoder Encoder₂, so as to obtain a second historical-dialogue encoded representation and a second candidate-response encoded representation, which are denoted as \vec{F₂^{h}} and \vec{F₂^{r}}, and expressed as follows:

\vec{F₂^{h}}=Encoder₂(\vec{Z₁^{h}});

\vec{F₂^{r}}=Encoder₂(\vec{Z₁^{r}});

where \vec{Z₁^{h}} represents the first historical-dialogue longitudinal self-screening feature representation; \vec{Z₁^{r}} represents the first candidate-response longitudinal self-screen feature representation; Encoder₂ represents the second-layer encoder;

performing cross-attention calculation on the second historical-dialogue encoded representation and the first historical-dialogue longitudinal self-screening feature representation, so as to obtain a second historical-dialogue longitudinal self-screening feature representation, which is denoted as \vec{Z₂^{h}}; performing cross-attention calculation on second the candidate-response encoded representation and the first candidate-response longitudinal self-screening feature representation, so as to obtain a second candidate-response longitudinal self-screening feature representation, which is denoted as \vec{Z₂^{r}}; performing concatenating operation on the second historical-dialogue encoded representation and the second candidate-response encoded representation, and using the self-attention mechanism to implement interactive processing therebetween, so as to obtain a second transverse interactive feature representation, which is denoted as \vec{I₂}, wherein expressions are as follows:

$$\vec{{Z}_{2}^{h}} = Cross - Attention ( \vec{{F}_{2}^{h}} ; \vec{{Z}_{1}^{h}} ) ; \\ \vec{{Z}_{2}^{r}} = Cross - Attention ( \vec{{F}_{2}^{r}} ; \vec{{Z}_{1}^{r}} ) ; \\ \vec{{I}_{2}} = Self - Attention ( Concat ( \vec{{F}_{2}^{h}} ; \vec{{F}_{2}^{r}} ) ) ;$$

where \vec{F₂^{h}} represents the second historical-dialogue encoded representation; \vec{Z₁^{h}} represents the first historical-dialogue longitudinal self-screening feature representation; \vec{F₂^{r}} represents the second candidate-response encoded representation; \vec{Z₁^{r}} represents the first candidate-response longitudinal self-screening feature representation;

performing encoding operation on the second historical-dialogue longitudinal self-screening feature representation and the second candidate-response longitudinal self-screening feature representation by a third-layer encoder Encoder₃; in a similar fashion, repeating the encoding operation for a plurality of times according to a predetermined hierarchical depth of the automatic dialogue model, until a final n-th historical-dialogue longitudinal self-screening feature representation, a final n-th candidate-response longitudinal self-screening feature representation and a final n-th transverse interactive feature representation are generated; performing encoding operation on a (n−1)-th historical-dialogue longitudinal self-screening feature representation and a (n−1)-th candidate-response longitudinal self-screening feature representation by a nth-layer encoder Encoderₙ, so as to obtain a n-th historical-dialogue encoded representation and a n-th candidate-response encoded representation, which are denoted as \vec{Fₙ^{h}} and \vec{Fₙ^{r}}, and are expressed as follows:

$$\vec{{F}_{n}^{h}} = {Encoder}_{n} ( \vec{{Z}_{n - 1}^{h}} ) ; \\ \vec{{F}_{n}^{r}} = {Encoder}_{n} ( \vec{{Z}_{n - 1}^{r}} ) ;$$

where \vec{Zₙ₋₁^{h}} represents the (n−1)-th historical-dialogue longitudinal self-screening feature representation; \vec{Zₙ₋₁^{r}} represents the (n−1)-th candidate-response longitudinal self-screening feature representation; Encoderₙ represents the nth-layer encoder;

performing cross-attention calculation on the n-th historical-dialogue encoded representation and the (n−1)-th historical-dialogue longitudinal self-screening feature representation, so as to obtain a n-th historical-dialogue longitudinal self-screening feature representation, which is denoted as \vec{Zₙ^{h}}; performing cross-attention calculation on n-th the candidate-response encoded representation and the (n−1)-th candidate-response longitudinal self-screening feature representation, so as to obtain a n-th candidate-response longitudinal self-screening feature representation, which is denoted as \vec{Zₙ^{r}}; performing coupling operation on the n-th historical-dialogue encoded representation and the n-th candidate-response encoded representation, and using a self-attention mechanism to implement interactive processing therebetween, so as to obtain a n-th transverse interactive feature representation, which is denoted as \vec{Iₙ}, wherein expressions are as follows:

$$\vec{{Z}_{n}^{h}} = Cross - Attention ( \vec{{F}_{n}^{h}} ; \vec{{Z}_{n - 1}^{h}} ) ; \\ \vec{{Z}_{n}^{r}} = Cross - Attention ( \vec{{F}_{n}^{r}} ; \vec{{Z}_{n - 1}^{r}} ) ; \\ \vec{{I}_{n}} = Self - Attention ( Concat ( \vec{{F}_{n}^{h}} ; \vec{{F}_{n}^{r}} ) ) ;$$

where \vec{Fₙ^{h}} represents the n-th historical-dialogue encoded representation; \vec{Zₙ₋₁^{h}} represents the (n−1)-th historical-dialogue longitudinal self-screening feature representation; \vec{Fₙ^{r}} represents the n-th candidate-response encoded representation; \vec{Zₙ₋₁^{r}} represents the (n−1)-th candidate-response longitudinal self-screening feature representation;
concatenating the first transverse interactive feature representation, the second transverse interactive feature representation, . . . , and the n-th transverse interactive feature representation, so as to obtain a deep transverse interactive feature representation, which is denoted as I_{depth}, and is expressed as follows:

\vec{I_{depth}}=Concat(\vec{I₁},\vec{I₂}, . . . ,\vec{Iₙ});

where \vec{I₁}, \vec{I₂}, and \vec{Iₙ} represent the first transverse interactive feature representation, the second transverse interactive feature representation and the n-th transverse interactive feature representation, respectively.

Preferably, the training an automatic dialogue model includes:
building a loss function, including: using cross entropy as the loss function, which is expressed as follows:

$${L}_{loss} = - {\sum }_{i = 1}^{n} ( {y}_{true} ) log ( {y}_{pred} ) ;$$

where yₜᵣᵤₑ is a true label; y_{pred} is a correct probability outputted by the model;
building an optimization function, comprising: after testing a plurality of optimization functions, selecting AdamW optimization function as the optimization function, wherein except that a learning rate is set as 2e-5, other hyper-parameters of AdamW are set to default values in pytorch;
when the automatic dialogue model has not been trained, training the automatic dialogue model to optimize parameters of the model; and when the automatic dialogue model has been trained, predicting which of candidate responses is the correct response by a label predicting module.

An automatic dialogue system based on deep bi-directional attention is provided, the system includes:
an automatic question-and-answer data set acquisition unit configured to download a published automatic dialogue data set from a network or build an automatic dialogue data set by itself;
an automatic question-and-answer model building unit configured to build an automatic dialogue model based on deep bi-directional attention; and
an automatic question-and-answer model training unit configured to train an automatic dialogue model by using the automatic dialogue data set to complete prediction of a candidate response.

Preferably, the automatic question-and-answer model building unit includes an input data building module, an embedding processing module, a deep bi-directional attention encoding module, a feature compressing module and a label predicting module;
the input data building module is configured to preprocess an original data set so as to build input data;
the embedding processing module is configured to perform embedding processing on the input data through a Token layer, a Segment layer and a Position layer, and add an embedded representation of the Token layer, an embedded representation of the Segment layer, and an embedded representation of the Position layer to obtain a historical-dialogue embedded representation and a candidate-response embedded representation;
the deep bi-directional attention encoding module is configured to receive the historical-dialogue embedded representation and the candidate-response embedded representation outputted by the embedding processing module, and then perform longitudinal self-screening feature encoding operation and transverse interactive feature encoding operation on the historical-dialogue embedded representation and the candidate-response embedded representation in sequence by using a multilayer encoder, so as to obtain a n-th historical-dialogue longitudinal self-screening feature representation, a n-th candidate-response longitudinal self-screening feature representation and a deep transverse interactive feature representation;
the feature compressing module is configured to perform full connection mapping processing (Dense) and ReLU mapping processing on the deep transverse interactive feature representation, and concatenate a mapping result with the n-th historical-dialogue longitudinal self-screening feature representation and the n-th candidate-response longitudinal self-screening feature representation, so as to obtain a bi-directional feature representation;
the label predicting module is configured to predict a probability that the current response is a correct response based on the bi-directional feature representation;
the automatic question-and-answer model training unit includes a loss function building module and an optimization function building module;
the loss function building module is configured to calculate an error between a prediction result and the true label by using a cross entropy loss function;
the optimization function building module is configured to train and adjust parameters to be trained in the model and reduce a prediction error.

More preferably, the implementation of the deep bi-directional attention encoding module includes:
performing encoding operation on the historical-dialogue embedded representation and the candidate-response embedded representation by a first-layer encoder Encoder₁, so as to obtain a first historical-dialogue encoded representation and a first candidate-response encoded representation, which are denoted as \vec{F₁^{h}} and \vec{F₁^{r}}, and are expressed as follows:

\vec{F₁^{h}}=Encoder₁(\vec{E^{h}});

\vec{F₁^{r}}=Encoder₁(\vec{E^{r}});

where \vec{E^{h}} represents the historical-dialogue embedded representation, \vec{E^{r}} represents the candidate-response embedded representation, and Encoder₁ represents the first-layer encoder;
performing cross-attention calculation on the first historical-dialogue encoded representation and the historical-dialogue embedded representation, so as to obtain a first historical-dialogue longitudinal self-screening feature representation, which is denoted as \vec{Z₁^{h}}; performing cross-attention calculation on the first candidate-response encoded representation and the candidate-response embedded representation, so as to obtain a first candidate-response longitudinal self-screening feature representation, which is denoted as \vec{Z₁^{r}}; performing coupling operation on the first historical-dialogue encoded representation and the first candidate-response encoded representation, and then using a self-attention mechanism to implement interactive processing therebetween, so as to obtain a first transverse interactive feature representation, which is denoted as \vec{I₁}, wherein their expressions as follows:

$$\vec{{Z}_{1}^{h}} = Cross - Attention ( \vec{{F}_{1}^{h}} ; \vec{{E}^{h}} ) ; \\ \vec{{Z}_{1}^{r}} = Cross - Attention ( \vec{{F}_{1}^{r}} ; \vec{{E}^{r}} ) ; \\ \vec{{I}_{1}} = Self - Attention ( Concat ( \vec{{F}_{1}^{h}} ; \vec{{F}_{1}^{r}} ) ) ;$$

where \vec{F₁^{h}} represents the first historical-dialogue encoded representation; \vec{E^{h}} represents the historical-dialogue embedded representation; \vec{F₁^{r}} represents the first candidate-response encoded representation; \vec{E^{r}} represents the candidate-response embedded representation;
performing encoding operation on the first historical-dialogue longitudinal self-screening feature representation and the first candidate-response longitudinal self-screening feature representation by a second-layer encoder Encoder₂, so as to obtain a second historical-dialogue encoded representation and a second candidate-response encoded representation, which are denoted as \vec{F₂^{h}} and F₂^{r}, and are expressed as follows:

\vec{F₂^{h}}=Encoder₂(\vec{Z₁^{h}});

\vec{F₂^{r}}=Encoder₂(\vec{Z₁^{r}});

where \vec{Z₁^{h}} represents the first historical-dialogue longitudinal self-screening feature representation; \vec{Z₁^{r}} represents the first candidate-response longitudinal self-screen feature representation; Encoder₂ represents the second-layer encoder;
performing cross-attention calculation on the second historical-dialogue encoded representation and the first historical-dialogue longitudinal self-screening feature representation, so as to obtain a second historical-dialogue longitudinal self-screening feature representation, which is denoted as \vec{Z₂^{h}}; performing cross-attention calculation on the second candidate-response encoded representation and the first candidate-response longitudinal self-screening feature representation, so as to obtain a second candidate-response longitudinal self-screening feature representation, which is denoted as \vec{Z₂^{r}}; performing concatenating operation on the second historical-dialogue encoded representation and the second candidate-response encoded representation, and then using a self-attention mechanism to implement interactive processing therebetween, so as to obtain a second transverse interactive feature representation, which is denoted as \vec{I₂}, wherein expressions are as follows:

$$\vec{{Z}_{2}^{h}} = Cross - Attention ( \vec{{F}_{2}^{h}} ; \vec{{Z}_{1}^{h}} ) ; \\ \vec{{Z}_{2}^{r}} = Cross - Attention ( \vec{{F}_{2}^{r}} ; \vec{{Z}_{1}^{r}} ) ; \\ \vec{{I}_{2}} = Self - Attention ( Concat ( \vec{{F}_{2}^{h}} ; \vec{{F}_{2}^{r}} ) ) ;$$

where \vec{F₂^{h}} represents the second historical-dialogue encoded representation; \vec{Z₁^{h}} represents the first historical-dialogue longitudinal self-screening feature representation; \vec{F₂^{r}} represents the second candidate-response encoded representation; \vec{Z₁^{r}} represents the first candidate-response longitudinal self-screening feature representation;
performing encoding operation on the second historical-dialogue longitudinal self-screening feature representation and the second candidate-response longitudinal self-screening feature representation by a third-layer encoder Encoder₃; in a similar fashion, repeating the encoding operation for a plurality of times according to a preset hierarchical depth of the automatic dialogue model, until the final n-th historical-dialogue longitudinal self-screening feature representation, the final n-th candidate-response longitudinal self-screening feature representation and the final n-th transverse interactive feature representation are generated; performing encoding operation on a (n−1)-th historical-dialogue longitudinal self-screening feature representation and a (n−1)-th candidate-response longitudinal self-screening feature representation by a nth-layer encoder Encoderₙ, so as to obtain a n-th historical-dialogue encoded representation and a n-th candidate-response encoded representation, which are denoted as \vec{Fₙ^{h}} and \vec{Fₙ^{r}}, and are expressed by as follows:

$$\vec{{F}_{n}^{h}} = {Encoder}_{n} ( \vec{{Z}_{n - 1}^{h}} ) ; \\ \vec{{F}_{n}^{r}} = {Encoder}_{n} ( \vec{{Z}_{n - 1}^{r}} ) ;$$

where \vec{Zₙ₋₁^{h}} represents the (n−1)-th historical-dialogue longitudinal self-screening feature representation; \vec{Zₙ₋₁^{r}} represents the (n−1)-th candidate-response longitudinal self-screening feature representation; Encoderₙ represents the nth-layer encoder;
performing cross-attention calculation on the n-th historical-dialogue encoded representation and the (n−1)-th historical-dialogue longitudinal self-screening feature representation, so as to obtain a n-th historical-dialogue longitudinal self-screening feature representation, which is denoted as \vec{Zₙ^{h}}; performing cross-attention calculation on the n-th candidate-response encoded representation and the (n−1)-th candidate-response longitudinal self-screening feature representation, so as to obtain a n-th candidate-response longitudinal self-screening feature representation, which is denoted as \vec{Zₙ^{r}}; performing concatenating operation on n-th the historical-dialogue encoded representation and the n-th candidate-response encoded representation, and then using a self-attention mechanism to implement interactive processing therebetween, so as to obtain a n-th transverse interactive feature representation, which is denoted as \vec{Iₙ}, wherein expressions are as follows:

$$\vec{{Z}_{n}^{h}} = Cross - Attention ( \vec{{F}_{n}^{h}} ; \vec{{Z}_{n - 1}^{h}} ) ; \\ \vec{{Z}_{n}^{r}} = Cross - Attention ( \vec{{F}_{n}^{r}} ; \vec{{Z}_{n - 1}^{r}} ) ; \\ \vec{{I}_{n}} = Self - Attention ( Concat ( \vec{{F}_{n}^{h}} ; \vec{{F}_{n}^{r}} ) ) ;$$

where \vec{Fₙ^{h}} represents the n-th historical-dialogue encoded representation; \vec{Zₙ₋₁^{h}} represents the (n−1)-th historical-dialogue longitudinal self-screening feature representation; \vec{Fₙ^{r}} represents the n-th candidate-response encoded representation; \vec{Zₙ₋₁^{r}} represents the (n−1)-th candidate-response longitudinal self-screening feature representation;
concatenating the first transverse interactive feature representation, the second transverse interactive feature representation, . . . , and the n-th transverse interactive feature representation, so as to obtain a deep transverse interactive feature representation, which is denoted as \vec{I_{depth}}, and is expressed as follows:

\vec{I_{depth}}=Concat(\vec{I₁},\vec{I₂}, . . . ,\vec{Iₙ});

where \vec{I₁}, \vec{I₂}, and \vec{Iₙ} represent the first transverse interactive feature representation, the second transverse interactive feature representation and the n-th transverse interactive feature representation, respectively.

An electronic device is provided, which includes a memory and at least one processor;
computer programs are stored in the memory;
the at least one processor executes the computer program stored in the memory, so that the at least one processor implement the automatic dialogue method based on deep bi-directional attention as described above.

A computer-readable storage medium is provided, computer program are stored in the computer-readable storage medium, and the computer program is executed by a processor to implement the automatic dialogue method based on deep bi-directional attention as described above.

The automatic dialogue method and system based on deep bi-directional attention according to the present disclosure have the following advantages.
(1) The present disclosure can effectively alleviate the problem of information loss in the semantic encoding process, and can enhance the semantic interaction between a historical dialogue and a candidate response, so as to improve the prediction accuracy of an automatic dialogue.
(2) The present disclosure performs embedding processing on the input data through the Token layer, the Segment layer and the Position layer, which can capture three types of embedded features in the historical dialogue and the candidate response, so as to obtain richer and more accurate embedded representation.
(3) The present disclosure uses deep bi-directional attention encoding, which can effectively alleviate the problem of information loss in the semantic encoding process, so as to obtain more complete and accurate semantic feature representation.
(4) The present disclosure uses deep bi-directional attention encoding, which can effectively enhance the semantic interaction between a historical dialogue and a candidate response, so as to improve the prediction accuracy of an automatic dialogue.
(5) Through feature compressing, the present disclosure can compress and aggregate a plurality of feature representations, thereby saving training resources and improving training efficiency.
(6) The present disclosure can effectively improve the prediction accuracy of the automatic dialogue model by combining the deep bi-directional attention encoding.

### BRIEF DESCRIPTION OF THE DRAWINGS

The present disclosure will be further explained with reference to the accompanying drawings hereinafter.

FIG. 1 is a flowchart of an automatic dialogue method based on deep bi-directional attention.

FIG. 2 is a flowchart of building an automatic dialogue model.

FIG. 3 is a flowchart of training an automatic dialogue model.

FIG. 4 is a structural block diagram of an automatic dialogue system based on deep bi-directional attention.

FIG. 5 is a schematic diagram of the implementation process of a deep bi-directional attention encoding module.

FIG. 6 is an interactive schematic diagram of an automatic dialogue system based on deep bi-directional attention.

### DETAILED DESCRIPTION OF THE EMBODIMENTS

The automatic dialogue method and system based on deep bi-directional attention of the present disclosure will be described in detail with reference to the drawings and specific embodiments hereinafter.

### Embodiment 1

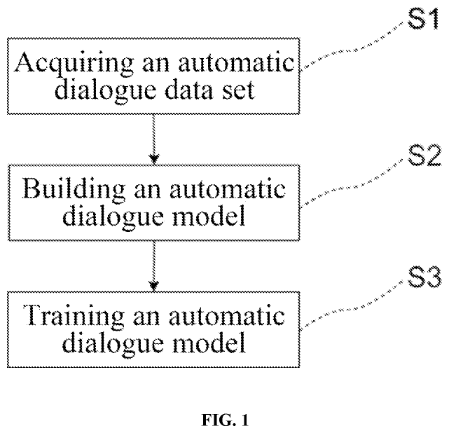

As shown in FIG. 1, this embodiment provides an automatic dialogue method based on deep bi-directional attention. The method specifically comprises the following steps S1-S3.

In S1, an automatic dialogue data set is acquired; a published automatic dialogue data set is downloaded from the network or the automatic dialogue data set is built by itself.

For example, there are many published automatic dialogue data sets on the Internet, such as Ubuntu Dialogue Corpus. The data format in the data set is shown in the following table:

| | | |
|---|---|---|
| Historical | S₁ | what is that ubuntu package that installs all the |
| dialogue | | mp3 codec the nvidia driver dvd support etc.? |
| | S₂ | you can do that easily with instructions provided |
| | | here |
| | S₃ | i remember there was some package that did it all |
| | | for you . . . called ez-something |
| | S₄ | easyubuntu |
| | S₅ | that be it . . . thanks |
| Candidate | Positive | man mount what flag am i looking for |
| response | (label: 1) | |
| | Negative | such as debconf dpkg-reconfigure reference |
| | (label: 0) | debconf(7) |

In a training set and a verification set, there is only one positive response (positive (label: 1)) and one negative response (negative (label: 0)) for the same historical dialogue sequence. In the test set, there is only one positive response (positive (label: 1)) and nine negative responses (negative (label: 0)).

In S2, an automatic dialogue model is built, particularly, an automatic dialogue model based on deep bi-directional attention is built.

In S3, an automatic dialogue model is trained, particularly, an automatic dialogue model is trained on the automatic dialogue data set.

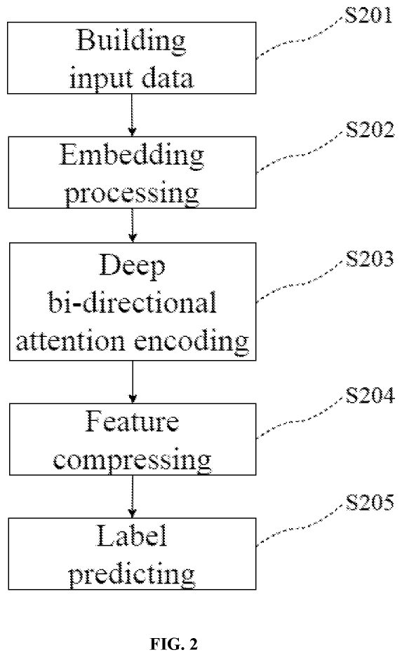

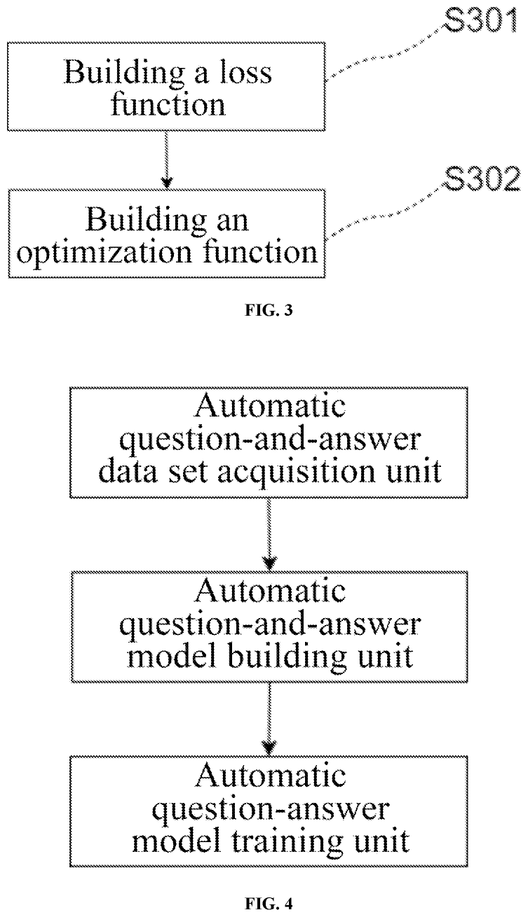

As shown in FIG. 2, building an automatic dialogue model in step S2 of this embodiment specifically comprises the following steps S210-S205.

In S201, an input data is built. Specifically, For each data in the automatic dialogue data set, all historical dialogue sentences are concatenated, and are separated from each other by a space character “[SEP]”, the result is denoted as h (history). A response is selected from a plurality of responses as a current response, and is formalized as r (response); the label of the piece of data is determined according to whether the response is correct, that is, if the response is correct, the label is denoted as 1; otherwise, the label is denoted as 0; in which h, r and the label form a piece of input data together.

For example, the data shown in step S1 is used as an example to form a piece of input data. The results are as follows:

(h:what is that ubuntu package that installs all the mp3 codec the nvidia driver dvd support etc.? [SEP] you can do that easily with instructions provided here [SEP] i remember there was some package that did it all for you . . . called ez-something [SEP] easyubuntu [SEP] that be it . . . thanks, r: man mount what flag am i looking for, 1)

In S202, embedding processing is performed. Specifically, embedding processing is performed on the input data through a Token layer, a Segment layer and a Position layer, and embedded representations of the three layers are added to obtain a historical-dialogue embedded representation and a candidate-response embedded representation, which specifically includes steps S20201-S20204.
In S20201, each word in the input data is converted into a vector with a fixed dimension through the Token layer, so as to obtain the embedded representation of the Token layer;
In S20202, different sentences in a historical dialogue sequence are differentiated through the Segment layer, so as to obtain the embedded representation of the Segment layer;
In S20203, a position where each word in the input data is located is identified through the Position layer, so as to obtain the embedded representation of the Position layer;
In S20204, the embedded representation of the Token layer, the embedded representation of the Segment layer and the embedded representation of the Position layer are added, so as to obtain the historical-dialogue embedded representation E^{h} and the candidate-response embedded representation E, which are expressed as follows:

$$\vec{{E}^{h}} = Token\_Emb ( h ) + Segment\_Emb ( h ) + Position\_Emb ( h ) ; \\ \vec{{E}^{r}} = Token\_Emb ( r ) + Segment\_Emb ( r ) + Position\_Emb ( r ) ;$$

where h represents a historical dialogue sequence; r represents a candidate response sequence; Token_Emb( ) represents the Token layer embedding operation; Segment_Emb( ) represents the Segment layer embedding operation; Position_Emb( ) represents the Position layer embedding operation.

For example, when the present disclosure is implemented on Ubuntu Dialogue Corpus data set, a embedding layer of a pre-training language model BERT is called to complete operations of embedding and adding the Token layer, the Segment layer, the Position layer, and a embedding dimension selects a dimension of the BERT embedding layer, that is, 768 dimensions. In pytorch, the code described above is implemented as follows:
# the embedding layer of bert is used to encode the input data.
history_embed=BERT.Embedding(history)
response_embed=BERT.Embedding(response)
   where history represents a historical dialogue sequence, history_embed is a historical-dialogue embedded representation, response represents a candidate response sequence, and response_embed is a candidate-response embedded representation.

In S203, deep bi-directional attention encoding is performed. A multi-layer encoder is used to perform a longitudinal self-screening feature encoding operation and a transverse interactive feature encoding operation on the historical-dialogue embedded representation and the candidate-response embedded representation, so as to obtain n-th historical-dialogue longitudinal self-screening feature representation, n-th candidate-response longitudinal self-screening feature representation and deep transverse interactive feature representation, which are denoted as \vec{Zₙ^{h}}, \vec{Zₙ^{r}} and \vec{I_{dpeth}};
In S204, feature compression is performed. One layer of fully connected network Dense is used to perform mapping processing on the deep transverse interactive feature representation to obtain the mapped deep transverse interactive feature representation; and then, the ReLU activation function is used to perform mapping processing on the mapped deep transverse interactive feature representation, so as to obtain the transverse interactive feature representation \vec{I}, which is expressed as follows:

\vec{I}=ReLU(Dense(I_{depth})).

For example, in pytorch, the code described above is implemented as follows:

$$self . dense = nn . Linear ( config . hidden\_size * 12 , config . hidden\_size ) \\ self . intermediate\_act \_fn = torch . nn . functional . relu \\ I = self . intermediate\_act \_fn ( self . dense ( I\_depth ) )$$

where config_hidden size is a encoding dimension, which is set to 768 in the present disclosure; I_depth is a deep transverse interactive feature representation; I is a transverse interactive feature representation.

The concatenating operation Concat is performed on the n-th historical-dialogue longitudinal self-screening feature representation, the n-th candidate-response longitudinal self-screening feature representation, and the transverse interactive feature representation, so as to obtain the bi-directional feature representation \vec{B}, which is expressed as follows:

\vec{B}=Concat(\vec{Zₙ^{h}},\vec{Zₙ^{r}},\vec{I});

For example, in pytorch, the code described above is implemented as follows:

$$B = torch . cat ( ( Z\_h \_n , Z\_r \_n , I ) , d i m = - 1 )$$

where Z_h_n is the n-th historical-dialogue longitudinal self-screening feature representation; Z_r_n is the n-th candidate-response longitudinal self-screening feature representation; I is the transverse interactive feature representation; B is the bi-directional feature representation.

In S205, label prediction is performed. The bi-directional feature representation is used as input, and is processed by a layer of fully connected network with dimension 1 and activation function Sigmod, so as to obtain a probability indicating that the current response is a correct response.

The embedding processing in step S202 of this embodiment is performed.

As shown in FIG. 5, deep bi-directional attention encoding in step S203 of this embodiment specifically includes S20301-S20307.

In S20301, encoding operation is performed on the historical-dialogue embedded representation and the candidate-response embedded representation by a first-layer encoder Encoder₁, so as to obtain the first historical-dialogue encoded representation and the first candidate-response encoded representation, which are denoted as \vec{F₁^{h}} and \vec{F₁^{r}}, which is expressed as follows:

\vec{F₁^{h}}=Encoder₁(\vec{E^{h}});

\vec{F₁^{r}}=Encoder₁(\vec{E^{r}});

where \vec{E^{h}} represents the historical-dialogue embedded representation, \vec{E^{r}} represents the candidate-response embedded representation, and Encoder₁ represents the first-layer encoder;
In S20302, cross-attention calculation is performed on the first historical-dialogue encoded representation and the historical-dialogue embedded representation, so as to obtain the first historical-dialogue longitudinal self-screening feature representation, which is denoted as \vec{Z₁^{h}}; cross-attention calculation is performed on the first candidate-response encoded representation and the candidate-response embedded representation, so as to obtain the first candidate-response longitudinal self-screening feature representation, which is denoted as \vec{Z₁^{r}}; at the same time, connecting operation is performed on the first historical-dialogue encoded representation and the first candidate-response encoded representation, and then a self-attention mechanism is used to complete the interactive processing therebetween, so as to obtain the first transverse interactive feature representation, which is denoted as \vec{I₁}, in which expressions are as follows:

$$\vec{{Z}_{1}^{h}} = Cross - Attention ( \vec{{F}_{1}^{h}} ; \vec{{E}^{h}} ) ; \\ \vec{{Z}_{1}^{r}} = Cross - Attention ( \vec{{F}_{1}^{r}} ; \vec{{E}^{r}} ) ; \\ \vec{{I}_{1}} = Self - Attention ( Concat ( \vec{{F}_{1}^{h}} ; \vec{{F}_{1}^{r}} ) ) ;$$

where \vec{F₁^{h}} represents the first historical-dialogue encoded representation; \vec{E^{h}} represents the historical-dialogue embedded representation; \vec{F₁^{r}} represents the first candidate-response encoded representation; \vec{E^{r}} represents the candidate-response embedded representation.

In S20303, encoding operation is performed on the first historical-dialogue longitudinal self-screening feature representation and the first candidate-response longitudinal self-screening feature representation by a second-layer encoder Encoder₂, so as to obtain the second historical-dialogue encoded representation and the second candidate-response encoded representation, which are denoted as \vec{F₂^{h}} and \vec{F₂^{r}}, which are expressed as follows:

\vec{F₂^{h}}=Encoder₂(\vec{Z₁^{h}});

\vec{F₂^{r}}=Encoder₂(\vec{Z₁^{r}});

where \vec{Z₁^{h}} represents the first historical-dialogue longitudinal self-screening feature representation; \vec{Z₁^{r}} represents the first candidate-response longitudinal self-screening feature representation; Encoder₂ represents the second-layer encoder.

In S20304, cross-attention calculation is performed on the second historical-dialogue encoded representation and the first historical-dialogue longitudinal self-screening feature representation, so as to obtain the second historical-dialogue longitudinal self-screening feature representation, which is denoted as \vec{Z₂^{h}}. A cross-attention calculation is performed on the second candidate-response encoded representation and the first candidate-response longitudinal self-screening feature representation, so as to obtain the second candidate-response longitudinal self-screening feature representation, which is denoted as \vec{Z₂^{r}}. At the same time, concatenating operation is performed on the second historical-dialogue encoded representation and the second candidate-response encoded representation, and then a self-attention mechanism is used to complete the interactive processing therebetween, so as to obtain the second transverse interactive feature representation, which is denoted as 2, in which expressions are as follows:

$$\vec{{Z}_{2}^{h}} = Cross - Attention ( \vec{{F}_{2}^{h}} ; \vec{{Z}_{1}^{h}} ) ; \\ \vec{{Z}_{2}^{r}} = Cross - Attention ( \vec{{F}_{2}^{r}} ; \vec{{Z}_{1}^{r}} ) ; \\ \vec{{I}_{2}} = Self - Attention ( Concat ( \vec{{F}_{2}^{h}} ; \vec{{F}_{2}^{r}} ) ) ;$$

where \vec{F₂^{h}} represents the second historical-dialogue encoded representation; \vec{Z₁^{h}} represents the first historical-dialogue longitudinal self-screening feature representation; \vec{F₂^{r}} represents the second candidate-response encoded representation; \vec{Z₁^{r}} represents the first candidate-response longitudinal self-screening feature representation.

In S20305, encoding operation is performed on the second historical-dialogue longitudinal self-screening feature representation and the second candidate-response longitudinal self-screening feature representation by a third-layer encoder Encoder₃; in a similar fashion, encoding is performed repeatedly according to a preset hierarchical depth of the automatic dialogue model, until a final n-th historical-dialogue longitudinal self-screening feature representation, the n-th candidate-response longitudinal self-screening feature representation and the n-th transverse interactive feature representation are generated; encoding operation is performed on the (n−1)-th historical-dialogue longitudinal self-screening feature representation and the (n−1)-th candidate-response longitudinal self-screening feature representation by the nth-layer encoder Encoderₙ, so as to obtain the n-th historical-dialogue encoded representation and the n-th candidate-response encoded representation, which are denoted as \vec{Fₙ^{h}} and \vec{Fₙ^{r}}, which are expressed as follows:

$$\vec{{F}_{n}^{h}} = {Encoder}_{n} ( \vec{{Z}_{n - 1}^{h}} ) ; \\ \vec{{F}_{n}^{r}} = {Encoder}_{n} ( \vec{{Z}_{n - 1}^{r}} ) ;$$

where \vec{Zₙ₋₁^{h}} represents the (n−1)-th historical-dialogue longitudinal self-screening feature representation; \vec{Zₙ₋₁^{r}} represents the (n−1)-th candidate-response longitudinal self-screening feature representation; Encoderₙ represents the nth-layer encoder;
In S20306, cross-attention calculation is performed on the n-th historical-dialogue encoded representation and the (n−1)-th historical-dialogue longitudinal self-screening feature representation, so as to obtain the n-th historical-dialogue longitudinal self-screening feature representation, which is denoted as \vec{Zₙ^{h}}; cross-attention calculation is performed on the n-th candidate-response encoded representation and the (n−1)-th candidate-response longitudinal self-screening feature representation, so as to obtain the n-th candidate-response longitudinal self-screening feature representation, which is denoted as \vec{Zₙ^{r}}; at the same time, connecting operation is performed on the n-th historical-dialogue encoded representation and the n-th candidate-response encoded representation, and then a self-attention mechanism is used to complete the interactive processing therebetween, so as to obtain the n-th transverse interactive feature representation, which is denoted as \vec{Iₙ}, in which the expressions are as follows:

$$\vec{{Z}_{n}^{h}} = Cross - Attention ( \vec{{F}_{n}^{h}} ; \vec{{Z}_{n - 1}^{h}} ) ; \\ \vec{{Z}_{n}^{r}} = Cross - Attention ( \vec{{F}_{n}^{r}} ; \vec{{Z}_{n - 1}^{r}} ) ; \\ \vec{{I}_{n}} = Self - Attention ( Concat ( \vec{{F}_{n}^{h}} ; \vec{{F}_{n}^{r}} ) ) ;$$

where \vec{Fₙ^{h}} represents the n-th historical-dialogue encoded representation; \vec{Zₙ₋₁^{h}} represents the (n−1)-th historical-dialogue longitudinal self-screening feature representation; F represents the n-th candidate-response encoded representation; \vec{Zₙ₋₁^{r}} represents the (n−1)-th candidate-response longitudinal self-screening feature representation;
In S20307, the first transverse interactive feature representation, the second transverse interactive feature representation, . . . , and the n-th transverse interactive feature representation are concatenated, so as to obtain the deep transverse interactive feature representation, which is denoted as \vec{I_{depth}}, which is expressed as follows:

\vec{I_{depth}}=Concat(\vec{I₁},\vec{I₂}, . . . ,\vec{Iₙ});

where \vec{I₁}, \vec{I₂}, and \vec{Iₙ} represent the first transverse interactive feature representation, the second transverse interactive feature representation and the n-th transverse interactive feature representation, respectively.

For example, when the present disclosure is implemented on Ubuntu Dialogue Corpus data set, the encoder Encoder selects Transformer Encoder, and the encoding dimension is set to 768; and a number of layers is set to 12.

Cross Attention selects a Dot-Product Attention calculation method. The calculation of the first historical-dialogue longitudinal self-screening feature representation is taken as an example, its calculation process is as follows:

$$F ( \vec{{F}_{1}^{h}} ; \vec{{E}^{h}} ) = \vec{{F}_{1}^{h}} ⊗ \vec{{E}^{h}} .$$

The expression realizes an interactive calculation between the first historical-dialogue encoded representation and the historical-dialogue embedded representation by dot product multiplication operation, F₁^{h} represents the first historical-dialogue encoded representation, E^{h} represents the historical-dialogue embedded representation, and ⊗ represents dot product multiplication operation.

$${α}_{i} = \frac{exp ( F ( \vec{{F}_{1}^{h}} , \vec{{E}_{i}^{h}} ) )}{{\sum }_{{i}^{′} = 1}^{l} exp ( F ( \vec{{F}_{1}^{h}} , \vec{{E}_{{i}^{′}}^{h}} ) )} , i = 1 , 2 , … , 1.$$

The above expression represents an attention weight α obtained by normalization operation, i and i′ represent element subscripts in the corresponding input tensors, l represents a number of elements in the input tensors E^{h}, and other symbols have the same meanings as the above expression;

$$\vec{Z} = {\sum }_{i = 1}^{l} {α}_{i} \vec{{E}_{i}^{h}} .$$

The above expression uses the obtained attention weight α to complete the feature screening of the historical-dialogue embedded representation, so as to obtain the first historical-dialogue longitudinal self-screening feature representation; l represents a number of elements in E^{h} and α.

Self-Attention selects a Self Dot-Product Attention calculation method, with the calculation of the first transverse interactive feature representation as an example. It is assumed that L=Concat(F₁^{h};F₁^{r}) The calculation process is as follows:

$$F ( \vec{L} , \vec{{L}^{T}} ) = \vec{L} ⊗ \vec{{L}^{T}} ;$$

The above expression indicates that the self-attention interaction calculation of a concatenating result of the first historical-dialogue encoded representation and the first candidate-response encoded representation is realized by dot product multiplication operation, L represents the concatenating result of the first historical-dialogue encoded representation and the first candidate-response encoded representation, and ⊗ represents dot product multiplication operation;

$${α}_{i} = \frac{exp ( F ( \vec{L} , \vec{{L}_{i}^{T}} ) )}{{\sum }_{{i}^{′} = 1}^{l} exp ( F ( \vec{L} , \vec{{L}_{{i}^{′}}^{T}} ) )} , i = 1 , 2 , … , 1 ;$$

The above expression represents the attention weight α obtained by normalization operation, i and i′ represent element subscripts in the corresponding input tensors, l represents a number of elements in the input tensors L, and other symbols have the same meanings as the above expression;

$$\vec{{I}_{1}} = {\sum }_{i = 1}^{l} {α}_{i} \vec{{L}_{i}^{T}} ;$$

The above expression indicates that the obtained attention weight α is used to complete the self-attention feature screening of the concatenating result of the first historical-dialogue encoded representation and the first candidate-response encoded representation, so as to obtain the first transverse interactive feature representation; l represents a number of elements in L and α.

In pytorch, the code described above is implemented as follows:

```
# Defining the calculation process of cross attention
def cross_attention(s1,s2):
    s1_s2_dot=tf.expand_dims(s1,axis=1)*tf.expand_dims(s2, axis=2)
    sd1= tf.multiply(tf.tanh(K.dot(s1_s2_dot, self.Wd)), self.vd)
    sd2 = tf.squeeze(sd1, axis =-1)
    ad = tf.nn.softmax(sd2)
    qdq = K.batch_dot(ad, s2)
    return qdq
# Defining the calculation process of self attention
def self_attention(s3):
    s4 = s3
    s3_s4_dot-tf.expand_dims(s3,axis=1)*tf.expand_dims(s4, axis=2)
    sd1= tf.multiply(tf.tanh(K.dot(s3_s4_dot, self.Wd)), self.vd)
    sd2 = tf.squeeze(sd1, axis =-1)
    ad = tf.nn.softmax(sd2)
    qdq = K.batch_dot(ad, s4)
    return qdq
# Defining the encoder
encoder_layer = nn.TransformerEncoderLayer(d_model=512, nhead=8)
self.transformer_encoder=nn.TransformerEncoder(encoder_layer,
um_layers=12)
# cyclic encoding
e_h = history_embed
e_r = response_embed
self.I = [ ]
for i in range(n):
    f_h = self.transformer_encoder.layers[i](e_h)
    f_r = self.transformer_encoder.layers[i](e_r)
    z_h = cross attention(f_h, e_h)
    z_r = cross_attention(f_r, e_r)
    lin = torch.cat((f_h, f_r),dim=1)
    self.I.append(self_attention(lin))
    e_h = z_h
    e_r = z_r
z_h_final = z_h
z_r_final = z_r
final_I = torch.cat(self.I,dim=-1)
```

history_embed represents the historical-dialogue embedded representation; response_embed represents the candidate-response embedded representation; z_h_final represents z_h_final; z_r_final represents the n-th candidate-response longitudinal self-screening feature representation; d_model represents a word vector size required by the encoder, which is set to 512 here; nhead represents a number of heads in the multi-head attention model, which is set to 8 here; um_layer represents a number of layers of the encoder, which is set to 12 here. The training automatic dialogue model in step S3 of this embodiment is as follows.

In S301, a loss function is built with a cross entropy as the loss function, which is expressed as follows:

$${L}_{loss} = - {\sum }_{i = 1}^{n} ( {y}_{true} ) log ( {y}_{pred} ) ;$$

where yₜᵣᵤₑ is a true label; y_{pred} is correct probability of model output.

For example, in pytorch, the code described above is implemented as follows.

# error between the predicted value and the label is calculated by the cross entropy loss function.

$$loss\_fct = CrossEntropyLoss ( ) \\ loss = loss\_fct ( logits . view ( - 1 , self . num\_labels ) , labels . view ( - 1 ) )$$

where labels are the true labels, and logits is the correct probability of model output.

In S302, an optimization function is built. After a plurality of optimization functions are tested, AdamW optimization function is finally selected as the optimization function, in which except that the learning rate is set as 2e-5, other hyper-parameters of AdamW are set to default values in pytorch.

For example, in pytorch, the code described above is implemented as follows.

$$optimizer = AdamW ( optimizer\_grouped \_parameters , lr = 2 e - 5 )$$

where optimizer_grouped_parameters are parameters to be optimized, which are all parameters in the automatic question-and-answer model by default.

When the automatic dialogue model has not been trained, it is necessary to train the automatic dialogue model to optimize the parameters of the model; and when the automatic dialogue model has been trained, a label predicting module predicts which one of the candidate responses is the correct response.

### Embodiment 2

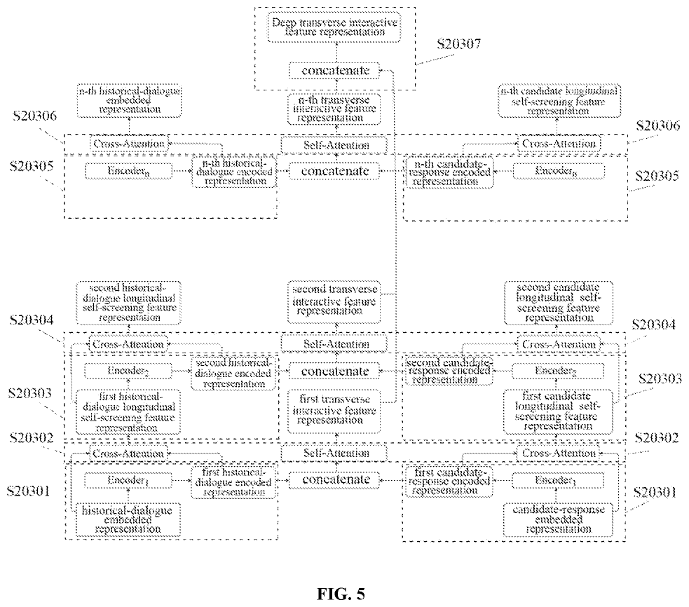

As shown in FIG. 4, this embodiment provides an automatic dialogue system based on deep bi-directional attention. The system includes an automatic question-and-answer data set acquisition unit, an automatic question-and-answer model building unit and an automatic question-and-answer model training unit.

The automatic question-and-answer data set acquisition unit is configured to download the published automatic dialogue data set from the network or build the automatic dialogue data set by itself.

The automatic question-and-answer model building unit is configured to build an automatic dialogue model based on deep bi-directional attention.

The automatic question-and-answer model training unit is configured to train an automatic dialogue model on the automatic dialogue data set to complete the prediction of the candidate response.

The automatic question-and-answer model building unit in this embodiment includes an input data building module, an embedding processing module, a deep bi-directional attention encoding module, a feature compressing module and a label predicting module.

The input data building module is configured to preprocess an original data set so as to build input data.

The embedding processing module is configured to perform embedding processing on the input data through a Token layer, a Segment layer and a Position layer, and add the embedded representation of the Token layer, the embedded representation of the Segment layer, and the embedded representation of the Position layer to obtain the historical dialogue embedded representation and the candidate response embedded representation.

The deep bi-directional attention encoding module is configured to receive the historical-dialogue embedded representation and the candidate-response embedded representation output by the embedding processing module, and then perform longitudinal self-screening feature encoding operation and transverse interactive feature encoding operation on the historical-dialogue embedded representation and the candidate-response embedded representation in sequence by using a multilayer encoder, so as to obtain the n-th historical-dialogue longitudinal self-screening feature representation, the n-th candidate-response longitudinal self-screening feature representation and the deep transverse interactive feature representation.

The feature compressing module is configured to perform full connection mapping processing (Dense) and ReLU mapping processing on the deep transverse interactive feature representation, and concatenate a mapping result with the n-th historical-dialogue longitudinal self-screening feature representation and the n-th candidate-response longitudinal self-screening feature representation, so as to obtain a bi-directional feature representation.

The label predicting module is configured to predict a probability that the current response is a correct response based on the bi-directional feature representation.

The automatic question-and-answer model training unit in this embodiment includes a loss function building module and an optimization function building module.

The loss function building module is configured to calculate an error between the prediction result and a true label by using the cross entropy loss function.

The optimization function building module is configured to train and adjust parameters to be trained in the model and reduce the prediction error.

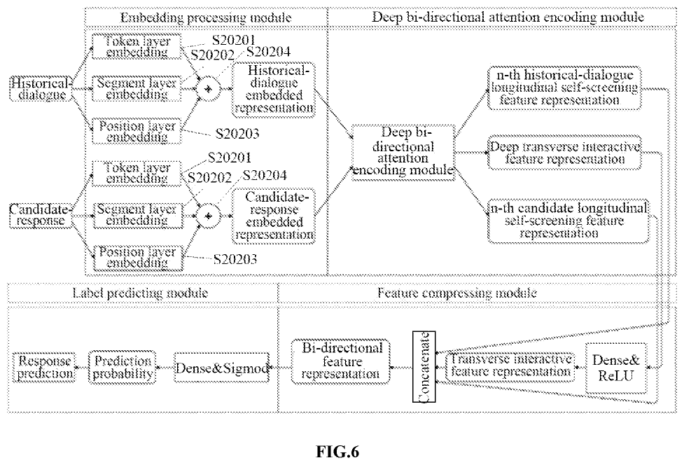

As shown in FIG. 6, the embedding processing module performs embedding processing on the input historical-dialogue and the candidate response through a Token layer, a Segment layer and a Position layer, and adds the embedded representation of the Token layer, the embedded representation of the Segment layer, and the embedded representation of the Position layer, so as to obtain the historical-dialogue embedded representation and the candidate-response embedded representation, and transmit the representations to the deep bi-directional attention encoding module. The deep bi-directional attention encoding module includes several layers of encoders. Each layer of encoders performs longitudinal self-screening feature encoding operation and transverse interactive feature encoding operation on the historical-dialogue embedded representation and the candidate-response embedded representation in sequence, so as to obtain the n-th historical-dialogue longitudinal self-screening feature representation, the n-th candidate-response longitudinal self-screening feature representation and the deep transverse interactive feature representation, and transmit the representations to the feature compressing module. The feature compressing module performs full connection mapping processing (Dense) and ReLU mapping processing on the deep transverse interactive feature representation, and concatenates the mapping result with the n-th historical-dialogue longitudinal self-screening feature representation and the n-th candidate-response longitudinal self-screening feature representation, so as to obtain the bi-directional feature representation and to transmit the representations to the label predicting module. The label predicting module maps the bi-directional feature representation to a floating-point value in a specified interval, and takes the value as a matching degree between the candidate response and the historical dialogue; then compares the matching degree of different responses, and takes the response with a highest matching degree as a correct response.

As shown in FIG. 5, a implementation of the deep bi-directional attention encoding module in this embodiment specifically includes as follows.

Encoding operation is performed on the historical-dialogue embedded representation and the candidate-response embedded representation by a first-layer encoder Encoder₁, respectively, so as to obtain the first historical-dialogue encoded representation and the first candidate-response encoded representation, which are denoted as \vec{F₁^{h}} and \vec{F₁^{r}}, which are expressed as follows:

\vec{F₁^{h}}=Encoder₁(\vec{E^{h}});

\vec{F₁^{r}}=Encoder₁(\vec{E^{r}});

where \vec{E^{h}} represents the historical-dialogue embedded representation, \vec{E^{r}} represents the candidate-response embedded representation, and Encoder₁ represents the first-layer encoder.

Cross-attention calculation is performed on the first historical-dialogue encoded representation and the historical-dialogue embedded representation, so as to obtain the first historical-dialogue longitudinal self-screening feature representation, which is denoted as \vec{Z₁^{h}}; cross-attention calculation is performed on the first candidate-response encoded representation and the candidate-response embedded representation, so as to obtain the first candidate-response longitudinal self-screening feature representation, which is denoted as \vec{Z₁^{r}}; at the same time, concatenating operation is performed on the first historical-dialogue encoded representation and the first candidate-response encoded representation, and then a self-attention mechanism is used to complete the interactive processing therebetween, so as to obtain the first transverse interactive feature representation, which is denoted as \vec{I₁}, in which the expressions are as follows:

$$\vec{{Z}_{1}^{h}} = Cross - Attention ( \vec{{F}_{1}^{h}} ; \vec{{E}^{h}} ) ;$$

$$\vec{{Z}_{1}^{r}} = Cross - Attention ( \vec{{F}_{1}^{r}} ; \vec{{E}^{r}} ) ;$$

$$\vec{{I}_{1}} = Self - Attention ( Concat ( \vec{{F}_{1}^{h}} ; \vec{{F}_{1}^{r}} ) ) ;$$

where \vec{F₁^{h}} represents the first historical-dialogue encoded representation; \vec{E^{h}} represents the historical-dialogue embedded representation; \vec{F₁^{r}} represents the first candidate-response encoded representation; \vec{E^{r}} represents the candidate-response embedded representation.

Encoding operation is performed on the first historical-dialogue longitudinal self-screening feature representation and the first candidate-response longitudinal self-screening feature representation by a second-layer encoder Encoder₂, respectively, so as to obtain the second historical-dialogue encoded representation and the second candidate-response encoded representation, which are denoted as \vec{F₂^{h}} and \vec{F₂^{r}}, which are expressed as follows:

\vec{F₂^{h}}=Encoder₂(\vec{Z₁^{h}});

\vec{F₂^{r}}=Encoder₂(\vec{Z₁^{r}});

where \vec{Z₁^{h}} represents the first historical-dialogue longitudinal self-screening feature representation; \vec{Z₁^{r}} represents the first candidate-response longitudinal self-screen feature representation; Encoder₂ represents the second-layer encoder.

Cross-attention calculation is performed on the second historical-dialogue encoded representation and the first historical-dialogue longitudinal self-screening feature representation, so as to obtain the second historical-dialogue longitudinal self-screening feature representation, which is denoted as \vec{Z₂^{h}}; cross-attention calculation is performed on the second candidate-response encoded representation and the first candidate-response longitudinal self-screening feature representation, so as to obtain the second candidate-response longitudinal self-screening feature representation, which is denoted as \vec{Z₂^{r}}; at the same time, concatenating operation is performed on the second historical-dialogue encoded representation and the second candidate-response encoded representation, and then a self-attention mechanism is used to complete the interactive processing therebetween, so as to obtain the second transverse interactive feature representation, which is denoted as \vec{I₂}, in which the expressions are as follows:

$$\vec{{Z}_{2}^{h}} = Cross - Attention ( \vec{{F}_{2}^{h}} ; \vec{{Z}_{1}^{h}} ) ;$$

$$\vec{{Z}_{2}^{r}} = Cross - Attention ( \vec{{F}_{2}^{r}} ; \vec{{Z}_{1}^{r}} ) ;$$

$$\vec{{I}_{2}} = Self - Attention ( Concat ( \vec{{F}_{2}^{h}} ; \vec{{F}_{2}^{r}} ) ) ;$$

where \vec{F₂^{h}} represents the second historical-dialogue encoded representation; \vec{Z₁^{h}} represents the first historical-dialogue longitudinal self-screening feature representation; \vec{F₂^{r}} represents the second candidate-response encoded representation; \vec{Z₁^{r}} represents the first candidate-response longitudinal self-screening feature representation.

Encoding operation is performed on the second historical-dialogue longitudinal self-screening feature representation and the second candidate-response longitudinal self-screening feature representation by a third-layer encoder Encoder₃, respectively; in a similar fashion, repeatedly encoding is performed for a plurality times according to a preset hierarchical depth of the automatic dialogue model, until the final n-th historical-dialogue longitudinal self-screening feature representation, the n-th candidate-response longitudinal self-screening feature representation and the n-th transverse interactive feature representation are generated; encoding operation is performed on the (n−1)-th historical-dialogue longitudinal self-screening feature representation and the (n−1)-th candidate-response longitudinal self-screening feature representation by a nth-layer encoder Encoderₙ, respectively, so as to obtain the n-th historical-dialogue encoded representation and the n-th candidate-response encoded representation, which are denoted as \vec{Fₙ^{h}} and \vec{Fₙ^{r}}, which are expressed as follows:

$$\vec{{F}_{n}^{h}} = {Encoder}_{n} ( \vec{{Z}_{n - 1}^{h}} ) ;$$

$$\vec{{F}_{n}^{r}} = {Encoder}_{n} ( \vec{{Z}_{n - 1}^{r}} ) ;$$

where \vec{Zₙ₋₁^{h}} represents the (n−1)-th historical-dialogue longitudinal self-screening feature representation; \vec{Zₙ₋₁^{r}} represents the (n−1)-th candidate-response longitudinal self-screening feature representation; Encoderₙ represents the nth-layer encoder.

Cross-attention calculation is performed on the n-th historical-dialogue encoded representation and the (n−1)-th historical-dialogue longitudinal self-screening feature representation, so as to obtain the n-th historical-dialogue longitudinal self-screening feature representation, which is denoted as n; cross-attention calculation is performed on the n-th candidate-response encoded representation and the (n−1)-th candidate-response longitudinal self-screening feature representation, so as to obtain the n-th candidate-response longitudinal self-screening feature representation, which is denoted as \vec{Zₙ^{r}}; at the same time, concatenating operation is performed on the n-th historical-dialogue encoded representation and the n-th candidate-response encoded representation, and then a self-attention mechanism is used to complete the interactive processing therebetween, so as to obtain the n-th transverse interactive feature representation, which is denoted as \vec{Iₙ}, in which the expressions are as follows:

$$\vec{{Z}_{n}^{h}} = Cross - Attention ( \vec{{F}_{n}^{h}} ; \vec{{Z}_{n - 1}^{h}} ) ;$$

$$\vec{{Z}_{n}^{r}} = Cross - Attention ( \vec{{F}_{n}^{r}} ; \vec{{Z}_{n - 1}^{r}} ) ;$$

$$\vec{{I}_{n}} = Self - Attention ( Concat ( \vec{{F}_{n}^{h}} ; \vec{{F}_{n}^{r}} ) ) ;$$

where \vec{Fₙ^{h}} represents the n-th historical-dialogue encoded representation; \vec{Zₙ₋₁^{h}} represents the (n−1)-th historical-dialogue longitudinal self-screening feature representation; \vec{Fₙ^{r}} represents the n-th candidate-response encoded representation; \vec{Zₙ₋₁^{r}} represents the (n−1)-th candidate-response longitudinal self-screening feature representation.

The first transverse interactive feature representation, the second transverse interactive feature representation, . . . , and the n-th transverse interactive feature representation are concatenated, so as to obtain the deep transverse interactive feature representation, which is denoted as \vec{I_{depth}}, and is expressed as follows:

\vec{I_{depth}}=Concat(\vec{I₁},\vec{I₂}, . . . ,\vec{Iₙ});

where \vec{I₁}, \vec{I₂}, and \vec{Iₙ} represent the first transverse interactive feature representation, the second transverse interactive feature representation and the n-th transverse interactive feature representation, respectively.

### Embodiment 3

The embodiment further provides an electronic device, which includes a memory and a processor.

The memory stores computer-executable instructions.

The processor executes the computer-executable instructions stored in the memory, so that the processor executes the automatic dialogue method based on deep bi-directional attention in any embodiment of the present disclosure.

The processor can be a central processing unit (CPU), other general-purpose processor, a digital signal processors (DSP), an application specific integrated circuit (ASIC), a field programmable gate arrays (FPGA) or other programmable logic device, a discrete gate or a transistor logic device, a discrete hardware component, etc. The processor can be a microprocessor or the processor can be any conventional processor, etc.

The memory can be used to store computer programs and/or modules. The processor can implement various functions of the electronic device by running or executing the computer programs and/or modules stored in the memory and calling data stored in the memory. The memory can mainly include a program storage area and a data storage area. The program storage area can store an operating system, an application program required by at least one function, etc.; and the data storage area can store data created according to use of the terminal, etc. In addition, the memory can further include a high-speed random access memory and a nonvolatile memory, such as a hard disk, a memory, a plug-in hard disk, a smart memory card (SMC), a secure digital (SD) card, a flash memory card, at least one disk storage device, a flash memory device, or other volatile solid-state storage device.

### Embodiment 4

The embodiment further provides a computer-readable storage medium, in which a plurality of instructions are stored, and the instructions are loaded by a processor, so that the processor executes the automatic dialogue method based on deep bi-directional attention in any embodiment of the present disclosure. Specifically, a system or device equipped with a storage medium is provided. The software program codes for implementing functions of any of the above embodiments is stored in the storage medium, so that the computer (or CPU or MPU) of the system or device reads out and executes the program codes stored in the storage medium.

In this case, the program code itself read from the storage medium can implement the functions of any of the above embodiments, and thus the program code and the storage medium storing the program code form a part of the present disclosure.

The embodiment of the storage medium for providing program codes includes floppy disks, hard disks, magneto-optical disks, optical disks (such as CD-ROM, CD-R, CD-RW, DVD-ROM, DVD-RYM, DVD-RW, DVD+RW), magnetic tapes, nonvolatile memory cards and ROMs. Alternatively, the program code can be downloaded from a server computer over a communication network.

In addition, it should be clear that the operating system and the like operated on the computer can complete some or all of actual operations by executing program codes read out by the computer or based on the instructions of the program codes, so as to implement the functions of any of the above embodiments.

In addition, it can be understood that program codes read from the storage medium is written into a memory provided in an expansion board inserted into the computer or is written into the memory provided in an expansion unit connected to the computer, and then the CPU and the like installed on the expansion board or the expansion unit execute some or all of actual operations based on instructions of the program codes, thereby realizing functions of any of the above embodiments.

Finally, it should be explained that the above embodiments are only used to illustrate the technical solutions of the present disclosure, rather than limit the technical solutions. Although the present disclosure has been described in detail with reference to the foregoing embodiments, it should be understood by those skilled in the art that the technical solutions described in the foregoing embodiments can be still modified, or some or all technical features thereof are equivalently replaced. These modifications or substitutions do not make the essence of the corresponding technical solutions depart from the scope of the technical solutions of various embodiments of the present disclosure.

What is claimed is:

1. An automatic dialogue method based on deep bi-directional attention, comprising:
acquiring an automatic dialogue data set, comprising downloading a published automatic dialogue data set from a network or building the automatic dialogue data set by itself,
building an automatic dialogue model, comprising building the automatic dialogue model based on deep bi-directional attention; and
training the automatic dialogue model, comprising training the automatic dialogue model by using the automatic dialogue data set.

2. The method according to claim 1, wherein the building an automatic dialogue model comprises:
building input data, comprising: for each piece of data in the automatic dialogue data set, concatenating all historical dialogue sentences, which are separated from each other by character symbols “[SEP]”, which is denoted as h; selecting a response from a plurality of candidate responses as a current response which is formalized as r; determining a label of the piece of data according to whether the response is correct, wherein, if the response is correct, the label is denoted as 1; otherwise, the label is denoted as 0; in which h, r and the label form a piece of input data together;
embedding processing: performing embedding processing on the input data through a Token layer, a Segment layer and a Position layer, and adding embedded representations of the three layers to obtain a historical-dialogue embedded representation and a candidate-response embedded representation;
deep bi-directional attention encoding: perform longitudinal self-screening feature encoding operation and transverse interactive feature encoding operation on the historical-dialogue embedded representation and the candidate-response embedded representation by using a multi-layer encoder, so as to obtain a n-th historical-dialogue longitudinal self-screening feature representation, a n-th candidate-response longitudinal self-screening feature representation and a deep transverse interactive feature representation, which are denoted as \vec{Zₙ^{h}}, \vec{Zₙ^{r}} and \vec{I_{depth}};
feature compressing: perform mapping processing on the deep transverse interactive feature representation by using a layer of fully connected Dense network, to obtain a mapped deep transverse interactive feature representation; and mapping the mapped deep transverse interactive feature representation by using a ReLU activation function, so as to obtain a transverse interactive feature representation \vec{I}, which is expressed as follows:
\vec{I}=ReLU(Dense(I_{depth}));
performing concatenating operation Concat on the n-th historical-dialogue longitudinal self-screening feature representation, the n-th candidate-response longitudinal self-screening feature representation, and the transverse interactive feature representation, so as to obtain a bi-directional feature representation \vec{B}, which is expressed as follows:
\vec{B}=Concat(\vec{Zₙ^{h}},\vec{Zₙ^{r}},\vec{I});
label predicting: subjecting the bi-directional feature representation as input to a layer of fully connected network with dimension 1 and an activation function Sigmod, so as to obtain a probability that the current response is a correct response.

3. The method according to claim 2, wherein the embedding processing comprises:
converting each word in the input data into a vector with a fixed dimension through the Token layer, so as to obtain an embedded representation of the Token layer;
differentiating different sentences in a historical dialogue sequence through the Segment layer, so as to obtain an embedded representation of the Segment layer;
identifying a position where each word in the input data is located through the Position layer, so as to obtain an embedded representation of the position layer;
adding the embedded representation of the Token layer, the embedded representation of the Segment layer and the embedded representation of the Position layer, so as to obtain a historical-dialogue embedded representation E^{h} and a candidate-response embedded representation E, which are expressed as follows:
$$\vec{{E}^{h}} = Token\_Emb ( h ) + Segment\_Emb ( h ) + Position\_Emb ( h ) ;$$
$$\vec{{E}^{r}} = Token\_Emb ( r ) + Segment\_Emb ( r ) + Position\_Emb ( r ) ;$$
where h represents a historical dialogue sequence; r represents a candidate response sequence; Token_Emb( ) represents a Token layer embedding operation; Segment_Emb ( ) represents a Segment layer embedding operation; Position_Emb ( ) represents a Position layer embedding operation.

4. The method according to claim 2, wherein deep bi-directional attention encoding comprises:
performing encoding operation on the historical-dialogue embedded representation and the candidate-response embedded representation by a first-layer encoder Encoder₁, respectively, so as to obtain a first historical-dialogue encoded representation and the first candidate-response encoded representation, which are denoted as \vec{F₁^{h}} and \vec{F₁^{r}}, which are expressed as follows:
\vec{F₁^{h}}=Encoder₁(\vec{E^{h}});
\vec{F₁^{r}}=Encoder₁(\vec{E^{r}});
where \vec{E^{h}} represents the historical-dialogue embedded representation, \vec{E^{r}} represents the candidate-response embedded representation, and Encoder₁ represents a first-layer encoder;
performing cross-attention calculation on the first historical-dialogue encoded representation and the historical-dialogue embedded representation, so as to obtain a first historical-dialogue longitudinal self-screening feature representation, which is denoted as \vec{Z₁^{h}}; performing cross-attention calculation on the first candidate-response encoded representation and the candidate-response embedded representation, so as to obtain a first candidate-response longitudinal self-screening feature representation, which is denoted as \vec{Z₁^{r}}; performing concatenating operation on the first historical-dialogue encoded representation and the first candidate-response encoded representation, and using a self-attention mechanism to implement interactive processing therebetween, so as to obtain a first transverse interactive feature representation, which is denoted as \vec{I₁}, wherein the expressions are as follows:
$$\vec{{Z}_{1}^{h}} = Cross - Attention ( \vec{{F}_{1}^{h}} ; \vec{{E}^{h}} ) ;$$
$$\vec{{Z}_{1}^{r}} = Cross - Attention ( \vec{{F}_{1}^{r}} ; \vec{{E}^{r}} ) ;$$
$$\vec{{I}_{1}} = Self - Attention ( Concat ( \vec{{F}_{1}^{h}} ; \vec{{F}_{1}^{r}} ) ) ;$$
where \vec{F₁^{h}} represents the first historical-dialogue encoded representation; \vec{E^{h}} represents the historical-dialogue embedded representation; \vec{F₁^{r}} represents the first candidate-response encoded representation; \vec{E^{r}} represents the candidate-response embedded representation;
performing encoding operation on the first historical-dialogue longitudinal self-screening feature representation and the first candidate-response longitudinal self-screening feature representation by a second-layer encoder Encoder₂, so as to obtain a second historical-dialogue encoded representation and a second candidate-response encoded representation, which are denoted as \vec{F₂^{h}} and \vec{F₂^{r}}, and expressed as follows:
\vec{F₂^{h}}=Encoder₂(\vec{Z₁^{h}});
\vec{F₂^{r}}=Encoder₂(\vec{Z₁^{r}});
where \vec{Z₁^{h}} represents the first historical-dialogue longitudinal self-screening feature representation; \vec{Z₁^{r}} represents the first candidate-response longitudinal self-screen feature representation; Encoder₂ represents the second-layer encoder;
performing cross-attention calculation on the second historical-dialogue encoded representation and the first historical-dialogue longitudinal self-screening feature representation, so as to obtain a second historical-dialogue longitudinal self-screening feature representation, which is denoted as \vec{Z₂^{h}}; performing cross-attention calculation on the second candidate-response encoded representation and the first candidate-response longitudinal self-screening feature representation, so as to obtain a second candidate-response longitudinal self-screening feature representation, which is denoted as \vec{Z₂^{r}}; performing concatenating operation on the second historical-dialogue encoded representation and the second candidate-response encoded representation, and then using the self-attention mechanism to implement interactive processing therebetween, so as to obtain a second transverse interactive feature representation, which is denoted as \vec{I₂}, wherein expressions are as follows:
$$\vec{{Z}_{2}^{h}} = Cross - Attention ( \vec{{F}_{2}^{h}} ; \vec{{Z}_{1}^{h}} ) ;$$
$$\vec{{Z}_{2}^{r}} = Cross - Attention ( \vec{{F}_{2}^{r}} ; \vec{{Z}_{1}^{r}} ) ;$$
$$\vec{{I}_{2}} = Self - Attention ( Concat ( \vec{{F}_{2}^{h}} ; \vec{{F}_{2}^{r}} ) ) ;$$
where \vec{F₂^{h}} represents the second historical-dialogue encoded representation; \vec{Z₁^{h}} represents the first historical-dialogue longitudinal self-screening feature representation; \vec{F₂^{h}} represents the second candidate-response encoded representation; \vec{Z₁^{r}} represents the first candidate-response longitudinal self-screening feature representation;
performing encoding operation on the second historical-dialogue longitudinal self-screening feature representation and the second candidate-response longitudinal self-screening feature representation by a third-layer encoder Encoder₃; in a similar fashion, repeating the encoding operation for a plurality of times according to a predetermined hierarchical depth of the automatic dialogue model, until a final n-th historical-dialogue longitudinal self-screening feature representation, a final n-th candidate-response longitudinal self-screening feature representation and a final n-th transverse interactive feature representation are generated; performing encoding operation on a (n−1)-th historical-dialogue longitudinal self-screening feature representation and a (n−1)-th candidate-response longitudinal self-screening feature representation by a nth-layer encoder Encoderₙ, so as to obtain a n-th historical-dialogue encoded representation and a n-th candidate-response encoded representation, which are denoted as \vec{Fₙ^{h}} and \vec{Fₙ^{r}}, and are expressed as follows:
$$\vec{{F}_{n}^{h}} = {Encoder}_{n} ( \vec{{Z}_{n - 1}^{h}} ) ;$$
$$\vec{{F}_{n}^{r}} = {Encoder}_{n} ( \vec{{Z}_{n - 1}^{r}} ) ;$$
where \vec{Zₙ₋₁^{h}} represents the (n−1)-th historical-dialogue longitudinal self-screening feature representation; \vec{Zₙ₋₁^{r}} represents the (n−1)-th candidate-response longitudinal self-screening feature representation; Encoderₙ represents the nth-layer encoder;
performing cross-attention calculation on the n-th historical-dialogue encoded representation and the (n−1)-th historical-dialogue longitudinal self-screening feature representation, so as to obtain a n-th historical-dialogue longitudinal self-screening feature representation, which is denoted as \vec{Zₙ^{h}}; performing cross-attention calculation on the n-th candidate-response encoded representation and the (n−1)-th candidate-response longitudinal self-screening feature representation, so as to obtain a n-th candidate-response longitudinal self-screening feature representation, which is denoted as \vec{Zₙ^{r}}; performing concatenating operation on the n-th historical-dialogue encoded representation and the n-th candidate-response encoded representation, and using the self-attention mechanism to implement interactive processing therebetween, so as to obtain a n-th transverse interactive feature representation, which is denoted as \vec{Iₙ}, wherein expressions are as follows:
$$\vec{{Z}_{n}^{h}} = Cross - Attention ( \vec{{F}_{n}^{h}} ; \vec{{Z}_{n - 1}^{h}} ) ;$$
$$\vec{{Z}_{n}^{r}} = Cross - Attention ( \vec{{F}_{n}^{r}} ; \vec{{Z}_{n - 1}^{r}} ) ;$$
$$\vec{{I}_{n}} = Self - Attention ( Concat ( \vec{{F}_{n}^{h}} ; \vec{{F}_{n}^{r}} ) ) ;$$
where \vec{Fₙ^{h}} represents the n-th historical-dialogue encoded representation; \vec{Zₙ₋₁^{h}} represents the (n−1)-th historical-dialogue longitudinal self-screening feature representation; \vec{Fₙ^{r}} represents the n-th candidate-response encoded representation; \vec{Zₙ₋₁^{r}} represents the (n−1)-th candidate-response longitudinal self-screening feature representation;
concatenating the first transverse interactive feature representation, the second transverse interactive feature representation, . . . , and the n-th transverse interactive feature representation, so as to obtain a deep transverse interactive feature representation, which is denoted as \vec{I_{depth}}, and is expressed as follows:
\vec{I_{depth}}=Concat(\vec{I₁},\vec{I₂}, . . . ,\vec{Iₙ});
where \vec{I₁}, \vec{I₂}, and \vec{Iₙ} represent the first transverse interactive feature representation, the second transverse interactive feature representation and the n-th transverse interactive feature representation, respectively.

5. The method according to claim 1, wherein the training the automatic dialogue model comprises:
building a loss function, comprising: using cross entropy as the loss function, which is expressed as follows:
$${L}_{loss} = - {\sum }_{i = 1}^{n} ( {y}_{true} ) log ( {y}_{pred} ) ;$$
where yₜᵣᵤₑ is a true label; y_{pred} is a correct probability outputted by the model;
building an optimization function, comprising: after testing a plurality of optimization functions, selecting AdamW optimization function as the optimization function, wherein except that a learning rate is set as 2e-5, other hyper-parameters of AdamW are set to default values in pytorch;
when the automatic dialogue model has not been trained, training the automatic dialogue model to optimize parameters of the model; and when the automatic dialogue model has been trained, predicting which of candidate responses is a correct response by a label predicting module.

6. An automatic dialogue system based on deep bi-directional attention, comprising:
an automatic question-and-answer data set acquisition unit, configured to download a published automatic dialogue data set from a network or build an automatic dialogue data set by itself;
an automatic question-and-answer model building unit, configured to build an automatic dialogue model based on deep bi-directional attention; and
an automatic question-and-answer model training unit, configured to train the automatic dialogue model by using the automatic dialogue data set to complete prediction of a candidate response.

7. The system according to claim 6, wherein the automatic question-and-answer model building unit comprises an input data building module, an embedding processing module, a deep bi-directional attention encoding module, a feature compressing module and a label predicting module;
the input data building module is configured to preprocess an original data set to build input data;
the embedding processing module is configured to perform embedding processing on the input data through a Token layer, a Segment layer and a Position layer, and add an embedded representation of the Token layer, an embedded representation of the Segment layer, and an embedded representation of the Position layer to obtain a historical-dialogue embedded representation and a candidate-response embedded representation;
the deep bi-directional attention encoding module is configured to receive the historical-dialogue embedded representation and the candidate-response embedded representation outputted by the embedding processing module, and perform longitudinal self-screening feature encoding operation and transverse interactive feature encoding operation on the historical-dialogue embedded representation and the candidate-response embedded representation in sequence by using a multilayer encoder, so as to obtain a n-th historical-dialogue longitudinal self-screening feature representation, a n-th candidate-response longitudinal self-screening feature representation and a deep transverse interactive feature representation;
the feature compressing module is configured to perform full connection mapping processing and ReLU mapping processing on the deep transverse interactive feature representation, and concatenate a mapping result with the n-th historical-dialogue longitudinal self-screening feature representation and the n-th candidate-response longitudinal self-screening feature representation, so as to obtain a bi-directional feature representation;
the label predicting module is configured to predict a probability that the current response is a correct response based on the bi-directional feature representation;
the automatic question-and-answer model training unit comprises a loss function building module and an optimization function building module;
wherein the loss function building module is configured to calculate an error between a prediction result and a true label by using a cross entropy loss function;
the optimization function building module is configured to train and adjust parameters to be trained in the model and reduce a prediction error.

8. The system according to claim 7, wherein implementation of the deep bi-directional attention encoding module comprises: performing encoding operation on the historical-dialogue embedded representation and the candidate-response embedded representation by a first-layer encoder Encoder₁, so as to obtain a first historical-dialogue encoded representation and a first candidate-response encoded representation, which are denoted as \vec{F₁^{h}} and \vec{F₁^{r}}, and are expressed as follows:
\vec{F₁^{h}}=Encoder₁(\vec{E^{h}});
\vec{F₁^{r}}=Encoder₁(\vec{E^{r}});
where \vec{E^{h}} represents the historical-dialogue embedded representation, \vec{E^{r}} represents the candidate-response embedded representation, and Encoder₁ represents the first-layer encoder;
performing cross-attention calculation on the first historical-dialogue encoded representation and the historical-dialogue embedded representation, so as to obtain a first historical-dialogue longitudinal self-screening feature representation, which is denoted as \vec{Z₁^{h}}; performing cross-attention calculation on the first candidate-response encoded representation and the candidate-response embedded representation, so as to obtain a first candidate-response longitudinal self-screening feature representation, which is denoted as \vec{Z₁^{r}}; performing concatenating operation on the first historical-dialogue encoded representation and the first candidate-response encoded representation, and using a self-attention mechanism to implement interactive processing therebetween, so as to obtain a first transverse interactive feature representation, which is denoted as \vec{I₁}, wherein their expressions are as follows:
$$\vec{{Z}_{1}^{h}} = Cross - Attention ( \vec{{F}_{1}^{h}} ; \vec{{E}^{h}} ) ;$$
$$\vec{{Z}_{1}^{r}} = Cross - Attention ( \vec{{F}_{1}^{r}} ; \vec{{E}^{r}} ) ;$$
$$\vec{{I}_{1}} = Self - Attention ( Concat ( \vec{{F}_{1}^{h}} ; \vec{{F}_{1}^{r}} ) ) ;$$
where \vec{F₁^{h}} represents the first historical-dialogue encoded representation; \vec{E^{h}} represents the historical-dialogue embedded representation; \vec{F₁^{r}} represents the first candidate-response encoded representation; \vec{E^{r}} represents the candidate-response embedded representation;
performing encoding operation on the first historical-dialogue longitudinal self-screening feature representation and the first candidate-response longitudinal self-screening feature representation by a second-layer encoder Encoder₂, so as to obtain a second historical-dialogue encoded representation and a second candidate-response encoded representation, which are denoted as \vec{F₂^{h}} and \vec{F₂^{r}}, and are expressed as follows:
\vec{F₂^{h}}=Encoder₂(\vec{Z₁^{h}});
\vec{F₂^{r}}=Encoder₂(\vec{Z₁^{r}});
where \vec{Z₁^{h}} represents the first historical-dialogue longitudinal self-screening feature representation; \vec{Z₁^{r}} represents the first candidate-response longitudinal self-screen feature representation; Encoder₂ represents the second-layer encoder;
performing cross-attention calculation on the second historical-dialogue encoded representation and the first historical-dialogue longitudinal self-screening feature representation, so as to obtain a second historical-dialogue longitudinal self-screening feature representation, which is denoted as \vec{Z₂^{h}}; performing cross-attention calculation on the second candidate-response encoded representation and the first candidate-response longitudinal self-screening feature representation, so as to obtain a second candidate-response longitudinal self-screening feature representation, which is denoted as \vec{Z₂^{r}}; performing concatenating operation on the second historical-dialogue encoded representation and the second candidate-response encoded representation, and using the self-attention mechanism to implement interactive processing therebetween, so as to obtain a second transverse interactive feature representation, which is denoted as \vec{I₂}, wherein expressions are as follows:
$$\vec{{Z}_{2}^{h}} = Cross - Attention ( \vec{{F}_{2}^{h}} ; \vec{{Z}_{1}^{h}} ) ;$$
$$\vec{{Z}_{2}^{r}} = Cross - Attention ( \vec{{F}_{2}^{r}} ; \vec{{Z}_{1}^{r}} ) ;$$
$$\vec{{I}_{2}} = Self - Attention ( Concat ( \vec{{F}_{2}^{h}} ; \vec{{F}_{2}^{r}} ) ) ;$$
where \vec{F₂^{h}} represents the second historical-dialogue encoded representation; \vec{Z₁^{h}} represents the first historical-dialogue longitudinal self-screening feature representation; \vec{F₂^{r}} represents the second candidate-response encoded representation; \vec{Z₁^{r}} represents the first candidate-response longitudinal self-screening feature representation;
performing encoding operation on the second historical-dialogue longitudinal self-screening feature representation and the second candidate-response longitudinal self-screening feature representation by a third-layer encoder Encoder₃; in a similar fashion, repeating the encoding operation for a plurality of times according to a preset hierarchical depth of the automatic dialogue model, until a final n-th historical-dialogue longitudinal self-screening feature representation, a final n-th candidate-response longitudinal self-screening feature representation and a final n-th transverse interactive feature representation are generated; performing encoding operation on a (n−1)-th historical-dialogue longitudinal self-screening feature representation and a (n−1)-th candidate-response longitudinal self-screening feature representation by a nth-layer encoder Encoderₙ, so as to obtain a n-th historical-dialogue encoded representation and a n-th candidate-response encoded representation, which are denoted as \vec{Fₙ^{h}} and \vec{Fₙ^{r}}, and are expressed by as follows:
$$\vec{{F}_{n}^{h}} = {Encoder}_{n} ( \vec{{Z}_{n - 1}^{h}} ) ;$$
$$\vec{{F}_{n}^{r}} = {Encoder}_{n} ( \vec{{Z}_{n - 1}^{r}} ) ;$$
where \vec{Zₙ₋₁^{h}} represents the (n−1)-th historical-dialogue longitudinal self-screening feature representation; \vec{Zₙ₋₁^{r}} represents the (n−1)-th candidate-response longitudinal self-screening feature representation; Encoderₙ represents the nth-layer encoder;
performing cross-attention calculation on the n-th historical-dialogue encoded representation and the (n−1)-th historical-dialogue longitudinal self-screening feature representation, so as to obtain a n-th historical-dialogue longitudinal self-screening feature representation, which is denoted as \vec{Zₙ^{h}}; performing cross-attention calculation on the n-th candidate-response encoded representation and the (n−1)-th candidate-response longitudinal self-screening feature representation, so as to obtain a n-th candidate-response longitudinal self-screening feature representation, which is denoted as \vec{Zₙ^{r}}; performing concatenating operation on the n-th historical-dialogue encoded representation and the n-th candidate-response encoded representation, and using a self-attention mechanism to implement interactive processing therebetween, so as to obtain a n-th transverse interactive feature representation, which is denoted as \vec{Iₙ}, wherein expressions are as follows:
$$\vec{{Z}_{n}^{h}} = Cross - Attention ( \vec{{F}_{n}^{h}} ; \vec{{Z}_{n - 1}^{h}} ) ;$$
$$\vec{{Z}_{n}^{r}} = Cross - Attention ( \vec{{F}_{n}^{r}} ; \vec{{Z}_{n - 1}^{r}} ) ;$$
$$\vec{{I}_{n}} = Self - Attention ( Concat ( \vec{{F}_{n}^{h}} ; \vec{{F}_{n}^{r}} ) ) ;$$
where \vec{Fₙ^{h}} represents the n-th historical-dialogue encoded representation; \vec{Zₙ₋₁^{h}} represents the (n−1)-th historical-dialogue longitudinal self-screening feature representation; \vec{Fₙ^{r}} represents the n-th candidate-response encoded representation; \vec{Zₙ₋₁^{r}} represents the (n−1)-th candidate-response longitudinal self-screening feature representation;
concatenating the first transverse interactive feature representation, the second transverse interactive feature representation, . . . , and the n-th transverse interactive feature representation, so as to obtain a deep transverse interactive feature representation, which is denoted as \vec{I_{depth}}, and is expressed as follows:
\vec{I_{depth}}=Concat(\vec{I₁},\vec{I₂}, . . . ,\vec{Iₙ});
where \vec{I₁}, \vec{I₂}, and \vec{Iₙ} represent the first transverse interactive feature representation, the second transverse interactive feature representation and the n-th transverse interactive feature representation, respectively.

9. An electronic device, comprising: a memory and at least one processor;
wherein computer programs are stored in the memory;
the at least one processor executes the computer programs stored in the memory, so that the at least one processor implement the automatic dialogue method based on deep bi-directional attention according to claim 1.

10. A computer-readable storage medium, wherein computer programs are stored in the computer-readable storage medium, and the computer program is executed by a processor to implement the automatic dialogue method based on deep bi-directional attention according to claim 1.
